(19) United States
(12) Patent Application Publication
(10) Pub. No.: US 2023/0122840 A1
(43) Pub. Date: Apr. 20, 2023

(54) ORTHOPEDIC DEVICE FOR AMBULATION ASSISTANCE AND SUITED FOR USE IN GAIT REHABILITATION OF THE TYPE INCLUDING MEANS FOR SPREADING THE THIGHS OF THE PATIENT APART

(71) Applicant: WEWALK TECH, Famars (FR)

(72) Inventor: RAMI HAIDAR, LILLE (FR)

(21) Appl. No.: 17/505,554

(22) Filed: Oct. 19, 2021

(51) Int. Cl. A61H 3/00

(52) U.S. Cl. CPC A61H 3/00; A61H 2201/0119; A61H 2201/164; A61H 2201/1261; A61H 2201/1436; A61H 2201/1671; A61H 2201/5058

(57) ABSTRACT

A gait rehabilitation device includes a stand equipped with casters spaced apart along the width and the length of the stand. Two movable arms forming a pedal crank, each arm comprising a first end rotatably mounted on the device about an axis parallel to the width of the stand. The wedging element to wedge the patient’s foot/leg is adjustable and lockable according to the width of the device. The thigh/leg spreader to adjustably space the patient’s thighs/legs on either side of the saddle support is configured to follow the alternating movement of the patient’s lower limbs. The position setting of the wedging element according to the width of the device is independent of the space setting of the thigh/leg spreader.

### BACKGROUND OF THE INVENTION

The document EP 3 598 961 A1 describes an orthopedic device for ambulation assistance and suited for use in gait rehabilitation, in particular for patients with multiple disabilities and having motor issues.

This device includes a stand which includes casters, a saddle support equipped with a saddle and articulated arms disposed on either side of the saddle support. The end of each of the articulated arms includes an element for wedging the foot or the leg of the patient which is mounted adjustable in position along the width of the stand. This wedging element allows spreading the legs of the patient apart on either side of the saddle, thereby avoiding frictions between the saddle and the thighs of the patient.

Yet, for some patients, it turns out to be necessary to spread both the thighs and the legs of the patient apart. Indeed, for some patients who have a low muscle tone, it turns out that one single blocking point at the thighs or at the leg creates tensions on the knees of the patient because the knees are no longer aligned with the thighs.

Moreover, the aforementioned document describes a motor-driven embodiment of the device. In this embodiment, the articulated arms include one motor on each of their joints. Afterwards, these motors should be controlled to simulate walking and drive the lower limbs of the patient. The motors being too many, it turns out that the control thereof to simulate walking is complicated. In addition, these motors are more fragile and it is difficult to connect them to an electric power supply source.

It also turns out that the device described in the aforementioned document is difficult to steer, either by the patient, or by a caregiver who pushes the device.

In addition, in the case where the device is provided with a foot bar sole, the patient finds it difficult to move and faces problems to change direction. The document WO 2012/049442 A1 describes a gait rehabilitation device that includes a stand equipped with casters spaced apart along the width and the length of the stand. This device includes a harness that supports the buttocks of the patient. The thighs of the patient are inserted in straps which cannot be spread apart. Hence, this device does not allow adjusting the spreading of the thighs of the patient. This device includes no pedal crank.

The document JP 2007 014698 A1 describes a device that enables ambulation of the patient. This device includes no saddle-carrier, or elements for wedging the foot or the leg of the patient adjustable and lockable in position along the width of the device. This device includes no pedal crank.

The document US 9 907 721 B2 describes a device that does not include any means for wedging the leg or the thighs of the patient. This device includes no pedal crank.

The document CN 107 874 984 A describes a gait assistance device that includes a belt retaining the patient. The legs of the patient are held at two poles of the support, which cannot be spread apart. This device includes no pedal crank.

The document KR 2018 0123939 A describes an ambulation assistance device that comprises an exoskeleton mounted on a movable support including casters. The two poles on which the lower limbs of the patient are fixed cannot be spread apart, so as to set the spreading of the thighs of the patient. This device includes no pedal crank.

### OBJECT AND SUMMARY OF THE INVENTION

The present invention aims to solve any one of the drawbacks related to the use of the device of the prior art.

In particular, the present invention aims to provide an ambulation assistance device that includes a pedal crank and allows setting the spreading of the feet and the legs of the patient or the spreading of the thighs and the feet/legs of the patient separately. Such a device allows adapting perfectly to the morphology of the patient and to his/her pathology. Indeed, the presence of the pedal crank involves an accurate positioning of the different portions of the lower limbs of the patient in order to cause no lesions during the use of the device.

The present invention relates to a gait rehabilitation device, of the type including a stand equipped with casters spaced apart along the width and the length of said stand, which defines the width and the length of said device, a saddle support possibly equipped with a saddle, which surmounts said stand and extends substantially vertically, according to the height of said device, said device comprising two movable arms forming a pedal crank, disposed on either side of said saddle support, each arm comprising a first end rotatably mounted on said device about an axis parallel to the width of said stand, said device further including, an element for wedging the foot or the leg of the patient, said wedging element being adjustable and lockable in position according to the width of the device.

In particular, according to the invention, the device also includes means for spacing the thighs or the legs of the patient apart on either side of said saddle support, said means for spreading the thighs apart allow modifying spreading of the thighs of the patient, said means for spreading the thighs or the legs apart are adjustable and lockable in position according to the width of said device and said spreading means are adapted to follow the alternating movement of the lower limbs of the patient maintained by said wedging elements and by said means for spreading the thighs or the legs apart, when the patient is installed on said device and the setting of the position of said wedging element according to the width of the device is independent of the setting of the means for spreading the thighs of the patient apart. According to a particular embodiment, the wedging element is mounted on the free end of each of the movable arms forming a pedal crank.

The position of the means for spreading the thighs or the legs apart is not limited according to the invention. They may be mounted on the movable arms forming a pedal crank or on the saddle support.

The presence of the means for spreading the thighs or the legs of the patient apart allows properly positioning the thighs, the legs, the knees and the feet of the patient according to an alignment that respects the physiology of the joints. Thus, the knees in particular could be set in a position that does not prevent walking and which does not cause a lesion of the joint. The spreading means also allow correcting the position of the hips of the patient which determines the position of the lower limbs of the latter. The element for wedging the leg or the foot and the means for spreading the thighs or the leg apart form means for guiding the leg during a walking movement.

In the case where the spreading means are mounted on the saddle support, they are easier to set as they are closer to the thighs or the legs.

According to a particular embodiment of the means for spreading the thighs apart, combinable with any one of the claims, they include two branches which extend on either side of the saddle support according to the width of the device and whose free end could be substantially spread apart from said saddle support according to the width of the device and locked in position, said free end of said branches including an element for fixing thigh or the leg, rotatably mounted about an axis parallel to the width of the device.

For example, the fixing element is intended to fix the thigh or the leg of the patient. It could be directly mounted in rotation on the end of the branch. It could also be rotatably mounted on the end of the branch through a pole that is rotatably mounted according to an axis parallel to the width of the device. In addition, it could be rotatably or pivotably mounted on the end of the pole. For example, it may consist of a curtain loop.

Advantageously, said spreading means are adjustable and lockable in position along the length and/or the height of said device.

For example, this could be obtained by mounting one end of the branches, movable on the saddle support along the length of the device and lockable in position. The spreading means may also comprise tube slidably mounted in the saddle support and carrying the two branches. The sliding tube allows setting, easily and simultaneously, the position of the two branches of the means for spreading the thighs apart along the length of the device.

The two branches being movable in rotation about an axis parallel to the width of the device, it is possible to set the position of the ends of the branches that carry the element for fixing the thigh along the height of the device.

According to a variant combinable with any one of the embodiments of the invention, in the case where the fixing element is mounted on the free end of the branch through a pole, it is advantageously mounted adjustable in position on the pole that connects it to the branch and its position on said pole is lockable, for example through blocking means. Thus, it is possible to easily adjust the position of the element for fixing the thigh or the leg without having to modify the position of all means for spreading the thighs or the legs apart along the length of the device.

According to another embodiment of the spreading means, the element for fixing the thigh or the leg is rotatably mounted about an axis parallel to the width of the device, adjustable in position along the length of this axis and lockable in position on this axis. This axis is secured to the device and may, in particular, be mounted on the saddle support. The rotational hinge of the fixing element allows following the alternating movement of the lower limbs of the patient, without disturbing walking and while ensuring a proper holding of the thighs or the legs.

In turn, the axis of rotation may be slidably mounted over said device, in particular in the proximity of the saddle support or beneath the latter.

In all embodiments, the element for fixing the thigh or the leg may be mounted on a ball-joint.

Advantageously, the means for spreading the thighs or the legs are disposed at the rear of the saddle support. Thus, they are easily accessible.

According to a particular variant, in the case where the spreading means include branches, each of said branches includes two parts, hinged relative to one another according to parallel axes, said parts forming a deformable parallelogram, one of said hinged parts includes a threaded rod crossing a thread formed in said part, said threaded rod allows deforming the parallelogram formed by said parts, thereby modifying the spreading of said branch with respect to said saddle support, according to the width of said device.

Such means turn out to be easy to finely set without any action on the patient. They are also robust and allow setting the position of the hips and of the lower limbs independently. Indeed, the spreading of each branch could thus be modified independently of the other one. It is frequent that the patients have positioning problems only at one hip. Thus, the spreading means allow correcting the wrong position of one single hip without modifying that of the other hip.

The aforementioned threaded rod avoids the branches tapering towards the saddle support, for example because of the movements of the patient. Advantageously, this variant may also include means for blocking the spreading of the branches which avoid the branches being spread apart along the width of the device. These blocking means may comprise a second rod provided with a stop and which crosses the other part, the length of the rod inserted between the two parts being adjustable and the second rod being adapted to be blocked in position on the part. Thus, the two parts are blocked in position with respect to one another. By modifying the length of the portion of the rods inserted between the parts, it is possible to reposition them around their axes and make the spreading of the branches vary along the width of the device. A spring or an elastically-deformable block may be placed between the part and the stop of the second rod in order to serve as a shock absorber. Thus, blocking is softer. Such a blocking is sometimes necessary depending on the pathology of the patient.

Regardless of the embodiment of the means for spreading the thighs or legs apart, they may comprise synchronization means which allow avoiding the two legs of the patient being aligned; indeed, the patient must always have one leg forwards and one leg rearwards. For example, these synchronization means may include a pulley on which slides a link that connects the two branches of the means for spreading the thighs or the legs apart, independently of the structure of the branches of the spreading means. The latter may be as mentioned before, or not.

Advantageously, said stand has a U-like shape whose opening is advantageously placed at the front of the device, the saddle support being mounted inside the U. Such a stand turns out to be perfectly stable.

According to one variant, said means for spacing the thighs apart comprise two lower lateral plates mounted parallel to one another on the saddle rod, on either side of the latter, said lower lateral plates respectively supporting slender arms to which supports for thigh or leg receptacles are fastened, said slender arms pivoting synchronously back and forth and vice versa about a first upper transverse axis and using connecting rods pivoting about secondary axes to alternately switch from a first position into a second position, the rotation of a slender arm in one direction causing the rotation of the other opposite arm in the opposite direction, and vice versa.

This solution allows accompanying the walking movement of the patient by guidance of his/her alternating movement while holding his/her thighs in a determined position and while imposing a natural and smooth walk.

Advantageously, each lower lateral plate is fastened on a central double-jaw clamping the saddle rod and is angularly adjustable individually with respect to said central jaw.

This solution allows adapting the device to different patient morphologies, and in particular the length of their stride.

More specifically, each lower lateral plate includes arcuate setting slots cooperating with screws fastened to the central double-jaw.

According to another aspect of the present invention, each lower lateral plate is crossed throughout its thickness by an arcuate setting groove inside which pairs of rings secured to the slender arms slip.

This solution allows for a smooth and guided movement of the slender arms and a walk of the patient that is as natural as possible.

Preferably, each arcuate guide groove includes front and rear stops against which the rings could bear respectively in the first and third positions.

Thus, this solution allows limiting the movements of the patient.

According to another feature of the present invention, each slender arm includes a pair of stabilization and guide pads constantly bearing against outer lateral faces of the corresponding lower lateral plates.

This solution allows avoiding the rehabilitation being done improperly, for example with no jolts or inadvertent lateral movements.

Advantageously, regardless of the embodiment of the device of the invention, it includes a central beam which extends according to the length of said stand and said second end of each of said movable arms is mounted slidably along said central beam and pivotably according to an axis parallel to the width of the device. The presence of the central beam allows fastening the two ends of the movable arms, which makes the pedal crank more robust and undeformable.

According to a particular embodiment, combinable with any one of the embodiments of the invention, said device includes a drive controller to drive said movable arms forming the pedal crank, said drive controller being adapted to alternately drive said movable arms in a rotational movement combined with a translation. The pedal crank being activated by an external force, it causes the movement of the device of the invention and walking of the patient. For example, the drive controller may consist of means for alternately driving the ends of the movable arms in rotation. The alternating drive is achieved by means of gears that are selected by and known to a person skilled in the art.

Said drive controller could include one or two rotary motors and/or at least one wheel connected to said movable arms, adapted to touch the ground and to be driven in rotation by the movement of said device on the ground.

The motor(s) may be electrically connected to a supply battery mounted on the device of the invention.

Advantageously, the motor(s) include(s) a safety that blocks their rotational movement when the patient exerts a force on one of the movable arms or both of them.

In the case where the device includes two motors, the movement of the pedal crank will replicate the walking movement. With one single motor, this movement is partially replicated. Indeed, it is more difficult to obtain the walking movement by means of gears.

In particular, the device includes a unique and common motor-drive device to control both the alternating movement of the pedal crank and the movement of the rear wheels.

More specifically, the motor-drive device includes a central motor driving on the one hand the arms (91,93) of the pedal crank through a first belt connected to a first gearmotor and on the other hand the rear wheels through a second belt connected to a second dis-engageable gearmotor.

According to one variant, the device includes a first central motor driving the arms of the pedal crank and independent motors to drive each rear wheel.

In particular, the device is provided with a manual piloting joystick/lever integrated to an armrest and piloting either one of the motors.

The element for wedging the foot or the leg could be as described in the prior art. The foot bar may be mounted adjustable on a perforated rod at the end of the sole (heel). It may also be mounted along its width. In this case, it may comprise two boards sliding within one another, as explained in more detail in the description of a particular embodiment of the foot bar.

According to a particular embodiment of the element for wedging the foot or the leg of the patient, it includes a foot bar which includes a sole whose lower surface is equipped with at least one rotary hooking element, said hooking element being made of an elastically-deformable material and rotatably mounted about an axis passing through the plane defined by the sole and forming a non-zero angle with the longitudinal dimension of said sole.

Advantageously, the aforementioned angle is comprised between 5 and 15° with a line parallel to the length of the foot bar.

Advantageously, said element for wedging the foot or the leg of the patient is mounted on said movable arm by means of a mounting element comprising damping means adapted to dampen the vertical movements of said wedging element.

The damping means may include a spring mounted between two stops so as to be able to be elastically deformed along the height of said device.

Advantageously, the device includes steering guide means, said guide means being selected in particular amongst a handlebar secured to a caster adapted to touch the ground and disposed at the front of said device, a bidirectional wheel possibly coupled to motor-driven rear casters equipping said stand and/or coupled to gripping means enabling an assistant to push said device, and/or it includes means for controlling said steering guide means and/or means for starting/stopping said drive controller of said movable arms, said control means and said start/stop means are selected independently of each other amongst a joystick, sensors disposed on the saddle when said device includes a saddle, sensors equipping means for maintaining the bust of the patient and means forming a gyroscope positioned so as to enable activation thereof by said patient.

The bidirectional wheel may be a multidirectional wheel. This wheel may be the wheel intended to drive the pedal crank in rotation; it then fills two functions: setting the pedal crank in movement when a caregiver pushes the device on the ground and steering guidance of the device, the latter being always set in movement by the caregiver, the bidirectional wheel enables the caregiver to change direction effectively.

The handlebar is indicated for patients who are capable of making use of their arms and of their hands. The sensors are rather indicated for patients who can only oscillate their bust, back and forth and left to right. In this case, the device may have no handlebar.

### BRIEF DESCRIPTION OF THE DRAWINGS

The present invention, its features and the different advantages conferred thereby will appear better upon reading the following description which refers to three particular embodiments, disclosed as illustrative and non-limiting examples and which refers to the appended drawings wherein:

FIG. 1 represents a three-dimensional profile view of a first particular embodiment;

FIG. 2 represents a particular embodiment of the means for spreading the thighs of the patient apart;

FIG. 3 represents a three-dimensional partial bottom view of the embodiment represented in FIG. 1;

FIG. 4 represents a three-dimensional partial view of a second embodiment, the motors being replaced with a bidirectional wheel;

FIG. 5 partially represents a third embodiment which includes means for holding the bust of the patient;

FIG. 6 represents a third embodiment of the means for spreading the thighs or the legs of the patient apart;

FIG. 7 represents a perspective overview of a motor-drive variant;

FIG. 8 represents another perspective overview of FIG. 7;

FIG. 9 represents a detail view of FIG. 7;

FIG. 10 represents a perspective overview of another motor-drive variant;

FIG. 11 represents a detail view of FIG. 10;

FIG. 12 represents a perspective overview of another motor-drive variant;

FIG. 13 represents a three-dimensional view of a device for holding the thighs of the patient in a first use position;

FIG. 14 represents another three-dimensional view of the holding device of FIG. 13;

FIG. 15 represents a three-dimensional view of the holding device of FIGS. 13 and 14 but in a second intermediate use position;

FIG. 16 represents another three-dimensional view of the holding device of FIG. 15;

FIG. 17 represents a three-dimensional view of the holding device of FIGS. 13 to 16 in a third use position; and

FIG. 18 represents another three-dimensional view of the holding device of FIG. 17.

### DETAILED DESCRIPTION OF THE EMBODIMENTS

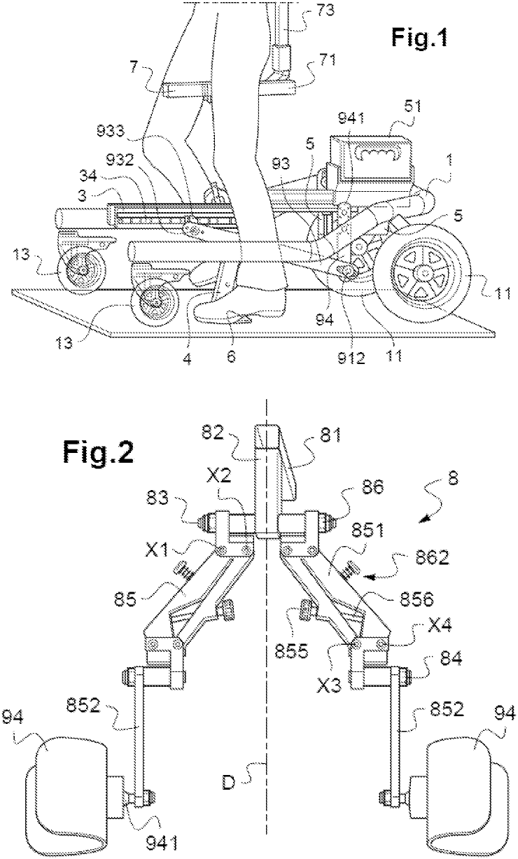

Referring to FIG. 1, a particular embodiment of the device D of the invention will now be described. In this embodiment, the device comprises a stand 1 which has a U-like general shape, the opening of the U being located at the front of the device, the front being defined according to the direction of movement of the device. The stand 1 includes two rear wheels 11 and two front casters 13, which are mounted pivotably-free about a vertical axis. The device includes a central beam 3 secured to the stand 1 and which extends between the two branches of the U formed by the stand 1. Two rotary motors 5 are mounted on either side of the central beam 2 and connected to an electric power supply battery 51, mounted on the top of the central beam 3. This battery 51 is possibly removable and could be recharged without the presence of the device of the invention. The device also includes a saddle support 7, which extends vertically and over which a saddle made of a polymer material could be fastened. For clarity, the saddle is not represented in FIG. 1. The saddle support 7 includes a hollow tube 71 (disposed at the end of a substantially vertical tube not shown in FIG. 1) which extends horizontally along the length of the device and a hinged vertical tube 73 over which a backrest or means for attaching the bust of the patient could be mounted. The saddle could be fastened on the tube 71.

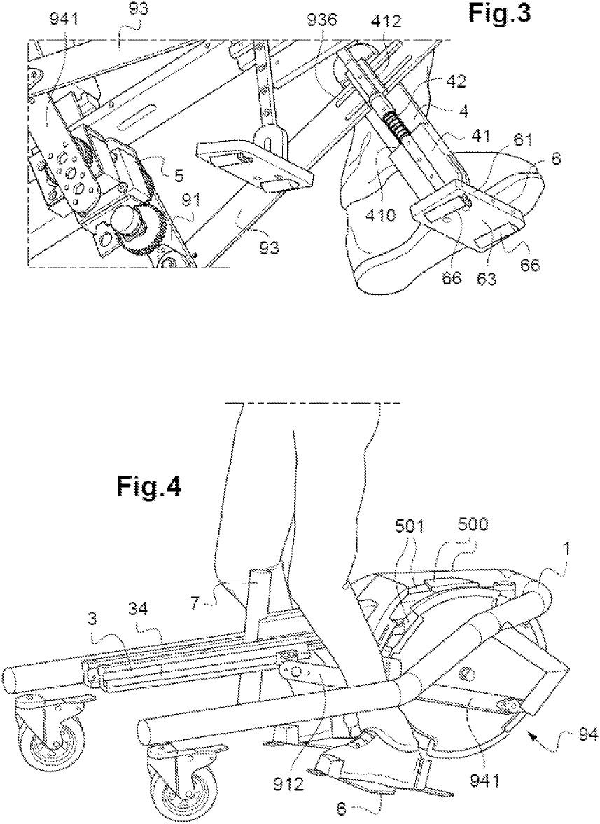

Referring to FIG. 1, the device also includes two movable arms each mounted on one side of the central beam 3. Each arm includes a first segment 91 one end of which is rotatably mounted about a horizontal axis extending along the width of the device (that is to say the width of the stand 1). The first end of a second segment 93 is mounted on the second end 912 of each of the first segments 91. The first end of the second segment 93 is rotatably mounted about a horizontal axis which extends along the width of the device. The second end 932 of the second end 93 is rotatably mounted about a horizontal axis which extends along the width of the device, on a part 933, which is slidably mounted on a horizontal rail 34 equipping the front of the central beam 3. The two segments 91 and 93 form a connecting rod and constitute a pedal crank; each of the rotary motors 5 drives first segment 91 in rotation. Each first segment 91 drives the second end of the second segment 93 in translation. Each second segment 93 includes a substantially vertical connecting part 4 which will be detailed further with reference to FIG. 3. The end of the connecting part 4 that is not mounted on the second segment 93 includes a foot bar 6 which extends along the length and the width of the device. This foot bar 6 is mounted adjustable in position according to the width of the device. Its position could be modified and then set according to the width of the device. The foot bar 6 will be described further with reference to FIG. 3.

The foot bar 6 may also be mounted adjustable in position as described in the document of the prior art.

In the embodiment represented in FIG. 1, the central beam 3 includes two portions mounted slidable within one another and whose relative position could be set by nut-bolt systems. Thus, it is possible to make the length of the central beam 3 vary according to the morphology of the patient. Similarly, the first segment 91 includes a series of perforations at its first end. These perforations allow making the length of the portion of the first segments 91 which extends between the rotation point and the second segment 93. Thus, it is possible to make the amplitude of the translational movement of the end of the second segment 93 vary, this movement corresponding to the stride of the patient. Similarly, the saddle support 7 is mounted adjustable in height and/or in inclination with respect to the stand 1, as indicated in the document of the prior art. The connecting part 4 also includes a series of perforations which allow making the distance between the foot bar 6 and the second segment 93 vary. The foot bar 6 is mounted movable in rotation on the end of the connecting part 4. Its angular position is variable and could be set; therefore, it also includes angular blocking means (not represented) which allow blocking its angular position with respect to the connecting part 4.

Referring to FIG. 2, a particular embodiment of the means for spreading the thighs or the legs of the patient 8 apart will now be described. According to this embodiment, the spreading means 8 include a horizontal tube 81 adapted to be slid within the hollow tube 71 of the saddle support 7. The tube 81 is fixed in position in the tube 71 by nut-bolt systems, for example. The tube 81 extends at one of its ends by a tube 82 which is vertical in FIG. 2. The end of the vertical tube 82 is provided with an axis of rotation 83, parallel to the width of the device. This axis of rotation 83 is horizontal and perpendicular to the tube 81. Branches 85 are mounted movable in rotation about the axis 83. Bolts 86 and washers allow fixing the position of the branches 85 on the axis 83. Each branch 85 is formed by two parts 851 both ends thereof are mounted movable about horizontal axes in FIG. 2, and parallel to the tube 81, respectively X1, X2, X3 and X4. Thus, the two parts 851 may be substantially brought away from the middle line D of the spreading means 8. The spreading of the branches 85 is adjusted via a knob 855 that equips the end of a threaded rod 856. The free end of the threaded rod 856 abuts on a portion of the outer part. By rotating the knob 855, the length of the threaded rod 856 portion that separates the two parts is modified; thus, the branch 85 is deformed, which results in bringing its end carrying the element for fixing the thigh or the leg 94 away from the middle line D. The more the threaded rod 856 is pushed in between the two parts 851, the more the branch 85 is brought away outwardly. An extension segment 852 extends the branch 85 and is rotatably mounted about a horizontal axis 84 parallel to the axis of rotation 83. The extension segment 852 could also be blocked in rotation by tightening a nut. The free end of the extension segment 852 is equipped with an element for fixing by tightening the leg or the thigh 94 (or tightening ring or also called element for fixing the thigh). This fixing element 94 includes a ball-joint 940 which allows directing the tightening element according to a rotation of about 360°.

According to a non-represented variant, the fixing/tightening element 94 and its ball-joint 940 are slidably mounted on the extension segment 852 and are lockable in position according to the length of the latter. This allows adapting the position of the tightening element 94 according to the morphology of the patient, its thighs being substantially away from the rear of the saddle support 7.

In FIG. 2, the blocking means extend vertically but when the tube 81 is inserted into the tube 71, the branches 85 are rotated about the axis 83 to bring them in a substantially horizontal plane, parallel to the stand 1. Thus, it is possible to insert the thighs of the patient in the tightening elements 9.

Referring to FIG. 3, a particular embodiment of the element for wedging the foot of the patient and of the connecting part 4 will now be described. In FIG. 3, the second segment 93 includes longitudinal slots 936 through which the connecting part 4 is mounted. Hence, the position of the connecting part 4 is adjustable along the second segment 93. The position of the connecting part 4 could be blocked, for example, with nut-bolt systems which tighten the connecting part 4 on the second segment 93 or using bolt-nut systems crossing the slots 936 and on which the part 4 abuts so as to prevent its translation in the slots 936. The part 4 includes a plate 41 whose end carries the foot bar 6 and the other end is fastened on the second segment 93 as explained before. The plate 41 includes a stop 410 which extends horizontally, along the thickness of the plate. The plate 41 is fastened on the second segment 93 by means of a fastening port 412 which forms, together with the part 4, a space enabling sliding of the connecting part 4 on the second segment 93, from the bottom to the op, along the width of the second segment 93. A spring 42 is disposed between the thickness of the fastening part 412 and the stop 410. The spring 42 has one end bearing on the stop 410 and the other one bearing on the thickness of the fastening part 412. This spring 42 enables the part 4 to be moved in its longitudinal dimension (i.e. vertically) relative to the second segment 93. The passage formed by the plate 41 and the fastening part 412 is larger than the width of the second segment 93 and therefore enables this vertical movement. Hence, the spring 42 enables the connecting part 4 to absorb the impacts and the changes in ground level during the movement of the foot bar 6.

Referring to FIG. 3, the foot bar 6 will now be described. The foot bar 6 includes a sole and is mounted at the end of the connecting part 4 along its width. The sole is defined as the surface over which the patients place his/her foot. The length of the foot bar 6 is defined along the length of the device. The foot bar 6 includes two hollow plates 61 and 63 which slide within one another and are lockable in position, by a screw-nut system, for example. These two plates 61 and 63 allow modifying the width of the foot bat 6 which allows positioning the foot of the patient in alignment with his/her leg and with his/her thigh. The lower face of the sole of the foot bar 6 includes two rolls 66 made of an elastically-deformable material. The rolls 66 are pivotably mounted about an axis substantially parallel to the length of the foot bar. Preferably, their axis of rotation forms an angle comprised between 5 and 15° with a line parallel to the length of the foot bar 6. The elastically-deformable material allows for a proper gripping of the sole of the foot bar 6 on the ground. The rolls 66 being pivotable, they enable the foot bar 6 to roll on the ground along its width. The inclination of their axis of rotation enables the foot bars 6 to easily roll on the ground during the changes of direction of the device of the invention.

According to a non-represented variant, combinable with any one of the embodiments of the device of the invention, the foot bar 6 includes a plate forming a sole which is fastened along one of its edges, to the foot bar 6 by a hinge which is parallel to the width of the foot bar 6. The plate forming a sole is hinged and could therefore be raised and blocked above the foot bar 6, its edge being secured to the hinge. A foot bar 6 including a board forming a hinged sole allows fixing the foot of the patient properly when this could not be positioned according to a 90° angle with the leg.

In all embodiments, the foot bar 6 includes means for fixing the foot of the patient which are not represented in the aforementioned figures, for clarity and simplicity purposes.

Referring to FIG. 4, a second embodiment will now be described. The elements common with the first embodiment are reference identically. In FIG. 4, the saddle support 7 has not been totally represented. In this second embodiment, the movable arm includes only one segment 91 whose end 912 is slidably and pivotably mounted on the central beam 3 as described with reference to the first embodiment. The other end of the first segment 91 is rotatably mounted on a wheel 500. Hence, the wheels 500 are disposed on either side of the central beam 3. The second end of the segment 91 is rotatably mounted on the wheel 500 about an axis parallel to the width of the device. The wheels 500 are bidirectional. They include rolls 501 which are adapted to roll along the width of the device, the wheel 500 rolling along the length of the device. This embodiment includes rear casters (not represented) which are motor-driven and actuated by control means enabling the patient to modify the direction of movement of the device of the invention, one caster moving forwards whereas the other moves backwards. This embodiment may also include, in addition to the motor-driven rear casters or in replacement thereof, gripping means enabling a caregiver to push the device of the invention. The wheels 500 also allow setting the segments 91 in movement, which simulate the walking movement.

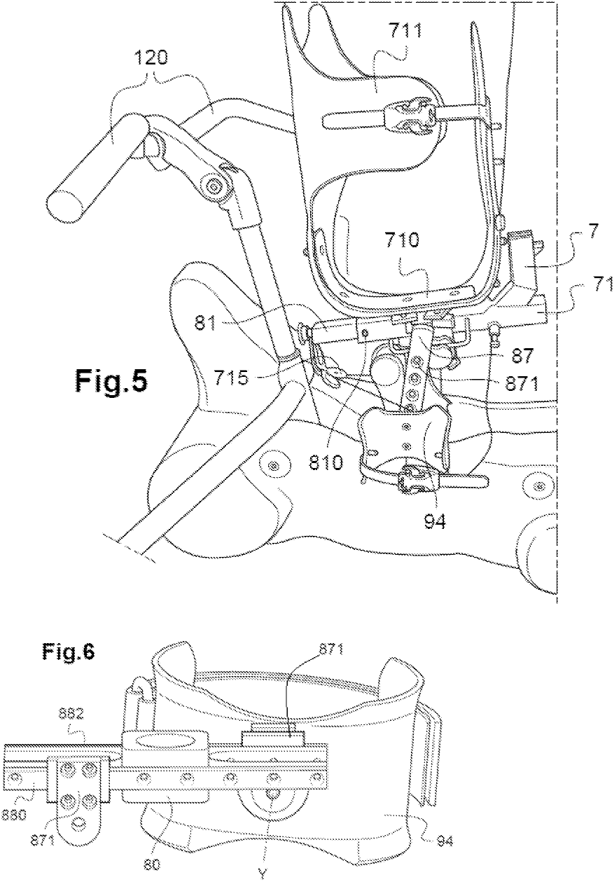

Referring to FIG. 5, an embodiment that includes means for holding the bust of the patient will now be described. The device is not replicated in its entirety in FIG. 4. Elements that are common with the other embodiments are references identically. The saddle support 7 is equipped with a saddle 710 made of rigid plastic. The saddle 710 which vertically extends, above the saddle support 7 at the chest and the back of the patient. The saddle also includes two sidewalls 711 provided with closure means which cooperate with the portion coming into contact with the chest of the patient. The saddle support 7 is pivotably mounted at the end of a substantially vertical tube belonging to the saddle 1; once adjusted, its angular position could be blocked. The support 1 includes gripping handles 120 enabling a caregiver to push the device of the invention. A pulley 715, mounted beneath the tube 81, lies at the rear of the saddle 710. A cord passes over the pulley and connects the two elements for tightening the thighs 9. Hence, the two elements for tightening the thighs 94 are connected by the cord which assists the patient in walking. Indeed, when the patient moves a lower limb forwards, the other lower limb will be pulled rearwards by the cord and the pulley, which provides a great help. The means for spreading the thighs or the legs apart include branches 87 that slide in the saddle support 7, along the width of the device, on each side of the saddle support 7 and along its length. The brackets or branches 87 could be blocked in position for example, by means of a threaded screw system which presses them against a horizontal wall of the saddle support 7. The free end of each bracket 87 carries the ring for tightening the thighs 94, which is mounted on the bracket 87 by means of a perforated post 871 which enables setting of the height of the ring 94. The ring 94 is mounted on the post 871 by means of a screw and a nut. The perforated post 871 is also rotatably mounted on the bracket 87, about an axis parallel to the width of the device, so as to allow following the movement of the lower limbs of the patient.

Referring to FIG. 6, a third embodiment of the means for spreading the thighs or the legs will now be described. Elements that are common with the other embodiments are referenced identically. This embodiment includes a pierced tube 80 which is crossed by the vertical tube that supports the horizontal tube 71 of the saddle support 7. Non-represented blocking means, allow, for example by tightening, blocking the pierced tube 80 in position on the vertical tube of the saddle support 7; the position of the tube 80 is therefore adjustable along the height of the device of the invention and lockable. The pierced tube 80 is secured to two rails 880 and 882 which extend on each side of the tube 80, parallel to the length of the device of the invention. A fastening plate 871 is slidably mounted on the first horizontal rail 880 and lockable in position on this rail. An identical fastening plate 871 is slidably mounted and lockable in position on the second rail 882. The element for fixing the thigh or the leg 94 is mounted on the fastening plate 871 by means of an axis Y which extends along the width of the device. The element for fixing the thigh or the leg 94 is mounted on the end of the Y axis by means of a ball-joint. Non-represented screws and nuts allow holding the fastening plate 871 in position on the rail 880 or 882, once the setting is completed. The fixing element 94 is also adjustable in position along the width of the device; it could actually slide over the aforementioned Y axis, which is a threaded axis that allows modifying the position of the fixing element 94 along the length of the axis. Afterwards, a nut allows blocking the fixing element 94 in position on the Y axis, enabling the setting of the latter along the width of the device. Hence, the pierced tube 80 enables setting of the spreading means along the height of the device; the rails 880 and 882 enable setting thereof along the length of the device and the Y axis and the nuts enable setting along the width of the device. The ball-joint on which the fixing element 94 is mounted enables the latter to follow the movements of the legs of the patient, which are moved by the movable arms forming a pedal crank or by the patient himself/herself.

In a non-represented variant of any one of the aforementioned embodiments, the device includes a handlebar which actuates a front wheel. This device enables the patients who could use their arms to steer the device of the invention.

In the case where the device includes means for setting the movable arms forming a pedal crank (rear motor or wheel) in movement, it could also include means for starting/stopping these means for setting in movement. For example, these start/stop means may consist of a joystick, a button or a controller. These control means may also comprise a tactile sensor, disposed on the saddle, at the thorax of the patient and/or a tactile sensor disposed at the back of the patient. Thus, by leaning forwards or rearwards, the patient could start or stop the means for setting in movement.

In the case where the device includes means for changing the direction of its movement, the device includes means for controlling these means. For example, these control means may include tactile sensors placed on the sidewalls 711 of the saddle 710. These sensors are coupled to motor-driven rear casters which, by their reverse rotation (one moving forwards, the other moving backwards), will modify the trajectory/direction of movement of the device. Such a device enables a patient whose cannot use his/her hands/arms to move with the device of the invention with the possibility of changing direction.

An example of use of the device of the invention will now be described.

First, it is proceeded with the setting of the different elements of the device. The length of the central beam 3, the height of the saddle, its inclination, the distance separating the foot bar 6 of the movable arm, the position of the ring for fixing the thigh 9 are set. Afterwards, the patient is placed on the saddle and his/her torso is held with the means for holding the torsion which possibly belong the saddle. The thighs of the patient are fixed in the rings 94 and the feet on the foot bar 6. When the means for spreading the thighs apart are as represented in FIG. 2, it is possible to finely set the spreading of the thighs simply by actuating the knobs 855. In the case where the device includes one or several wheel(s) 500, a caregiver could drive the movable arms by pushing the device and therefore simulating walking. The wheel 500 being bidirectional, the caregiver could change the direction of movement of the device of the invention.

In the case where the device includes one or two motor(s), the patient, himself/herself, could start the operation of the motors by pressing his/her torso forwards so as to press a sensor which will turn one the motor(s). A sensor at the rear allows stopping the motor(s).

In the case where the device includes lateral sensors, the patient could direct the device of the invention by swinging his/her bust to the right or to the left. The motor-driven rear casters and the wheels 500 enable the direction change.

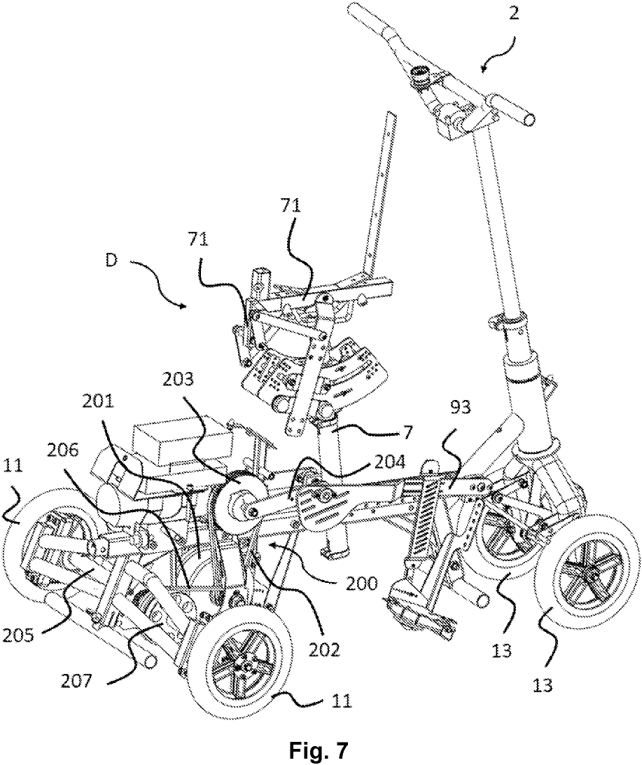

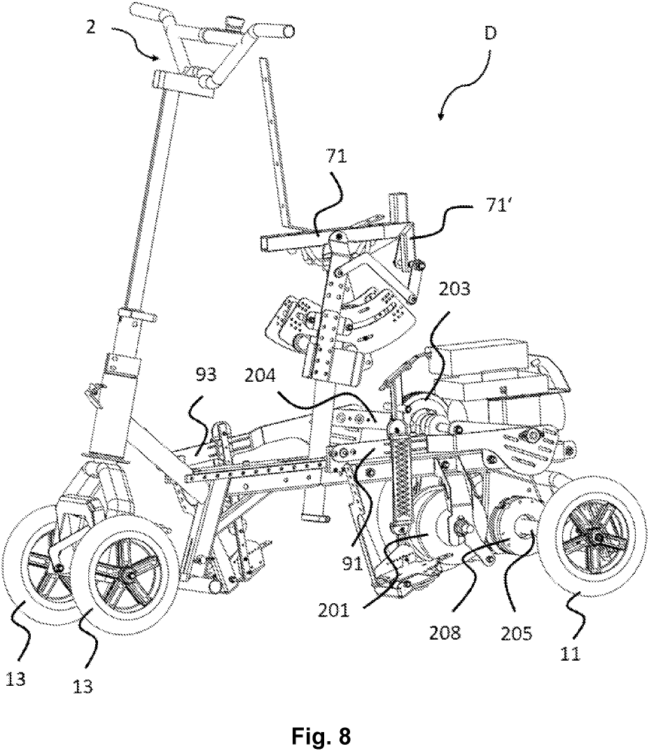

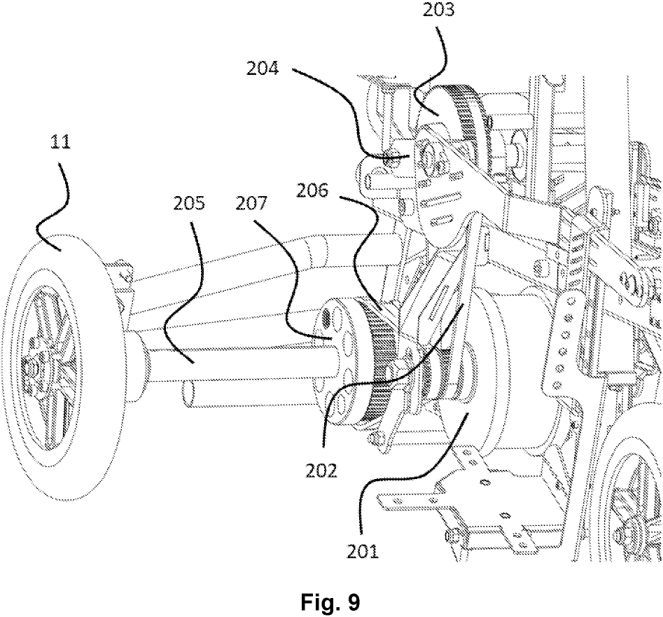

FIGS. 7 to 9 relate to a first embodiment of a motor-drive member 200 of the ambulation assistance and rehabilitation device, bearing the reference D in its entirety.

As described before, the ambulation assistance device D includes a saddle support 7, which extends vertically and over which a saddle made of a polymer material could be fastened, and a handlebar 2 to steer it manually, where possible. For clarity, the saddle is not represented in the figures. The saddle support 7 includes a hollow tube 71 which extends horizontally along the length of the device and a sliding portion 71′ of which extends downwards.

In this first design mode, the motor-drive member 200 includes a unique central motor 201 secured to a rear portion of the device D and connected on the one hand to the pedal crank 91/93 using a first toothed belt 202 engaged with a first gearmotor 203 secured to a hand crank 204 and, on the other hand, to the motor axle 205 of the rear wheels 11 using a second toothed belt 206 engaged with a second gearmotor 207. A power-off brake system 208 is also provided on the axis of the motor axle 205 to secure the vehicle in slopes, as illustrated in FIG. 8.

In this first mode, the ratio between the speed of movement and the speed of the pedal crank is therefore fixed. Hence, the motor-drive member 200 allows making the pedal crank 91/93 rotate for rehabilitation and ambulation assistance, but also to make the device D move forwards. The drive power transmission to the rear wheels 11 could be disengaged and enable rehabilitation at stop, with the device D stationary and the pedal crank 91/93 rotating. This motor-drive architecture is suited more particularly to patients who could use their arms to accelerate and steer the vehicle using the handlebar 2.

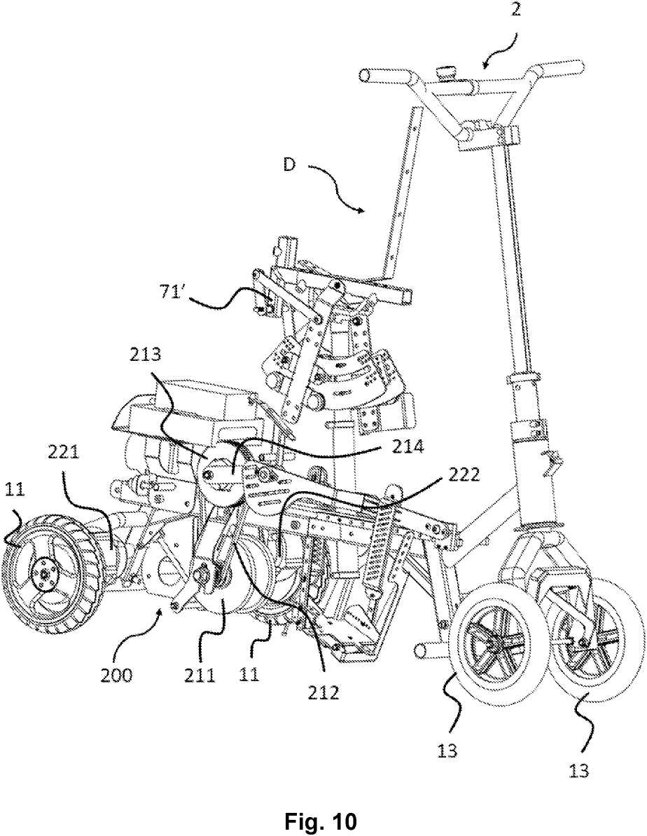

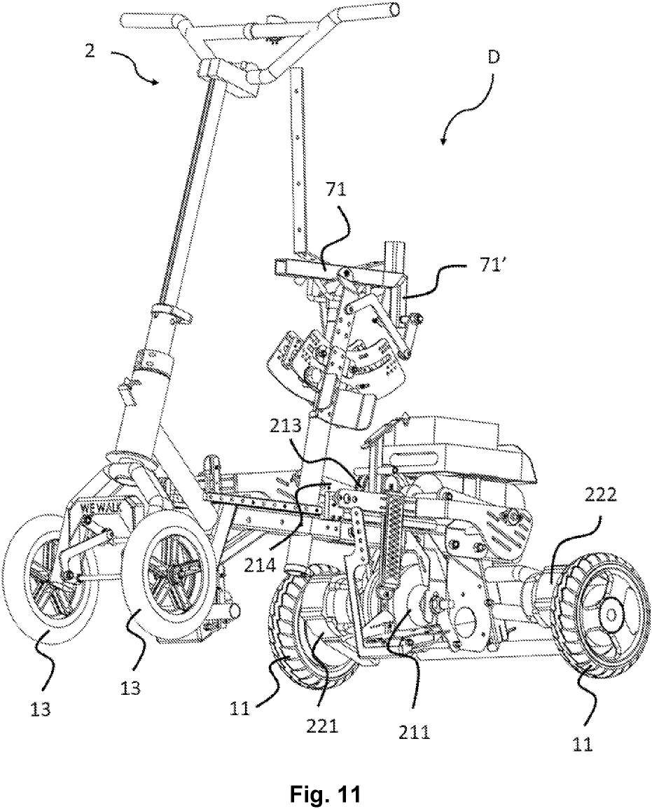

FIGS. 10 and 11 relate to a second embodiment of the motor-drive member 200 of the ambulation assistance device D.

In this second mode, the motor-drive member 200 includes a first central motor 211 secured to a rear portion of the device D and connected only to the pedal crank 91/93 using a first toothed belt 212 engaged with a first gearmotor 213 secured to a hand crank 214, and two secondary motors 221 and 222 each connected to a corresponding rear wheel 11. A power-off brake system is also integrated in each secondary motor 221 and 222 in order to secure the vehicle D in slopes. This configuration offers the same functions as the first embodiment but also allows decoupling the speed of advance of the vehicle (secondary motors) and the speed of the pedal crank (main motor). This motor-drive architecture is suited more particularly to patients who could use their arms to accelerate and steer the vehicle using the handlebar 2.

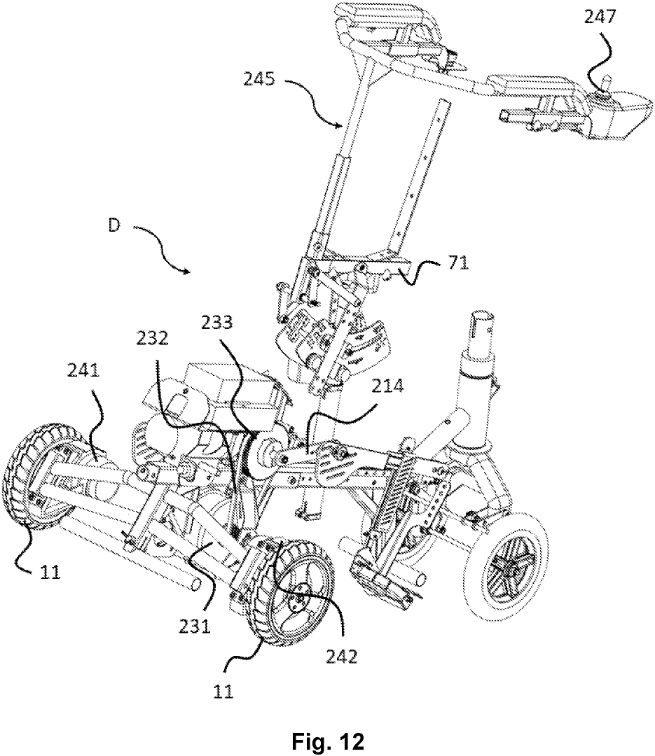

In turn, FIG. 12 relates to a third embodiment of the motor-drive member 200 of the ambulation assistance device D.

In this third mode, the motor-drive element 200 includes a first central motor 231 connected only to the pedal crank using a first toothed belt 232 engaged with a first gearmotor 233 secured to a hand crank 214, and two secondary motors 241 and 242 connected to each of the rear wheels. An armrest 245 is mounted on the saddle rod 7 and includes a joystick 247 for controlling the secondary motors 241 and 242.

The central motor 231 may operate alone in order to enable a rehabilitation without moving, while remaining sitting on the vehicle D. A power-off brake system is also integrated in each secondary motor 241 and 242 in order to secure the vehicle in slopes. This motor-drive architecture is suited to patients who could not use their arms to accelerate and steer the vehicle, which is therefore piloted using the joystick 247. The vehicle D turns thanks to the speed difference between the right-side and left-side motor-driven rear wheels 11.

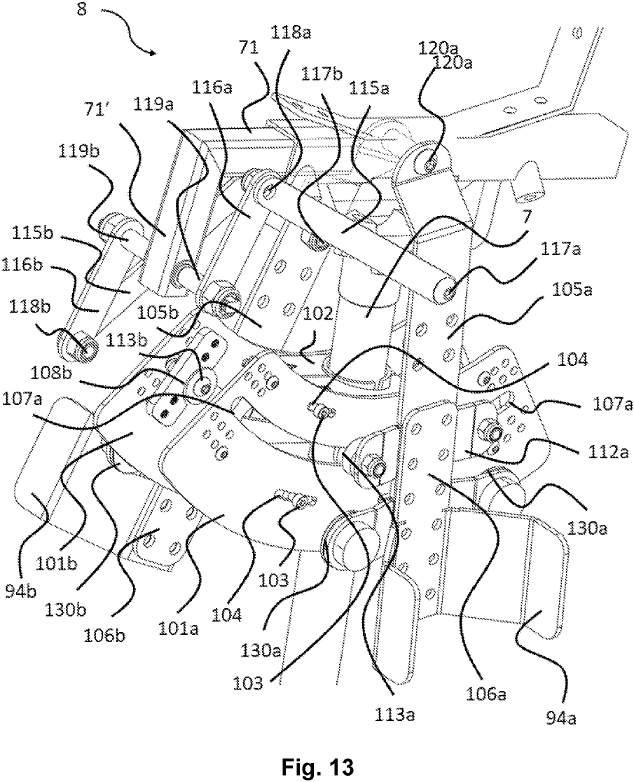

FIGS. 13 to 18 show a variant of the means 8 for spreading the thighs of the patient apart illustrated in FIGS. 7 to 12, which are illustrated in three different typical use positions.

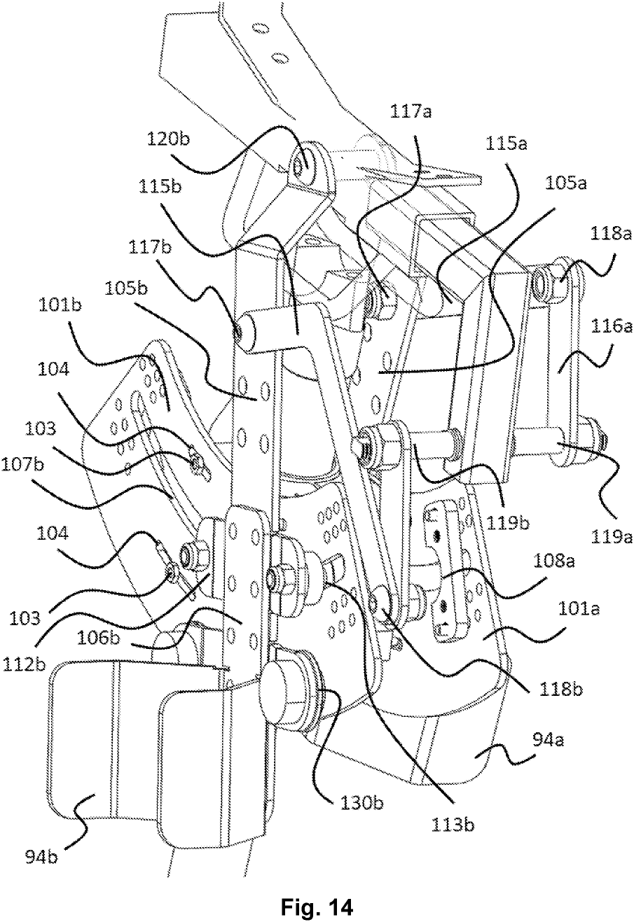

More specifically, FIGS. 13 and 14 show the spreading means 8 in a first position in which the right thigh of the patient is placed at the front, and the left thigh is placed, at the opposite, at the rear, according to the direction of movement of the orthopedic ambulation assistance device.

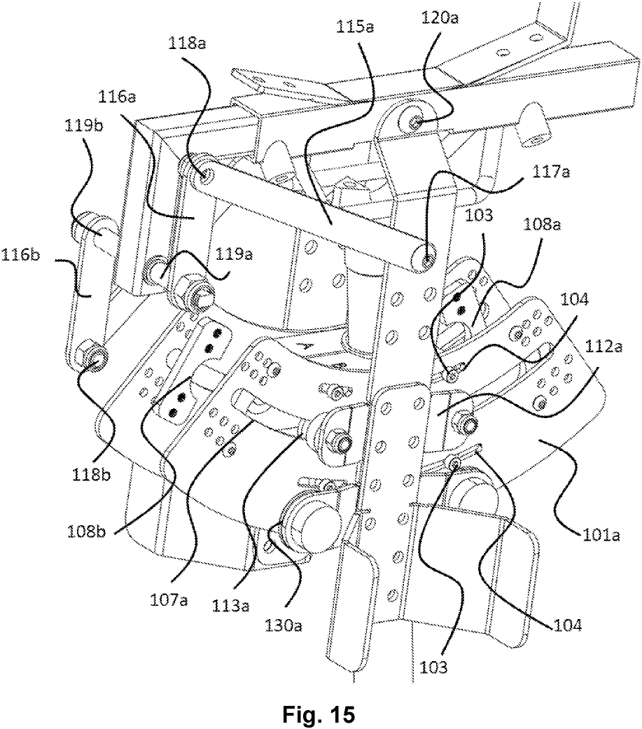

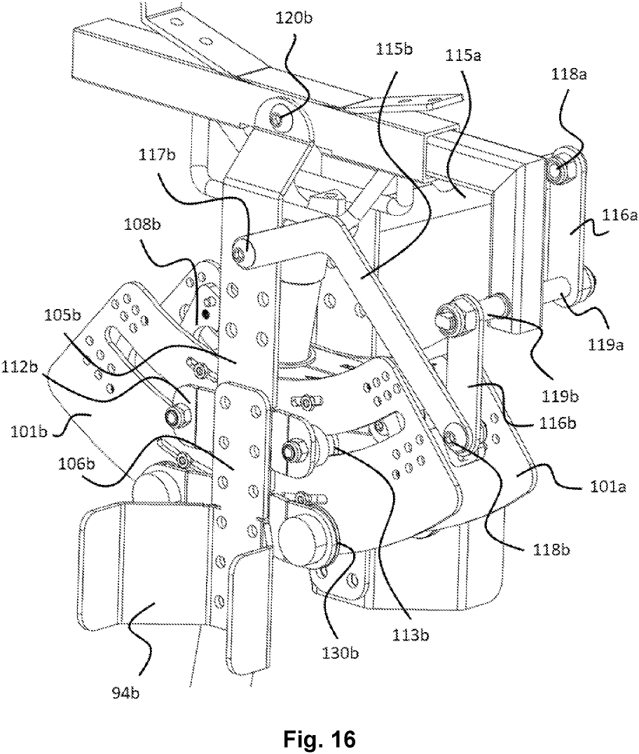

FIGS. 15 and 16 show the spreading means 8 in a so-called middle second intermediate position in which the right and left thighs are placed substantially opposite one another after their respective movements.

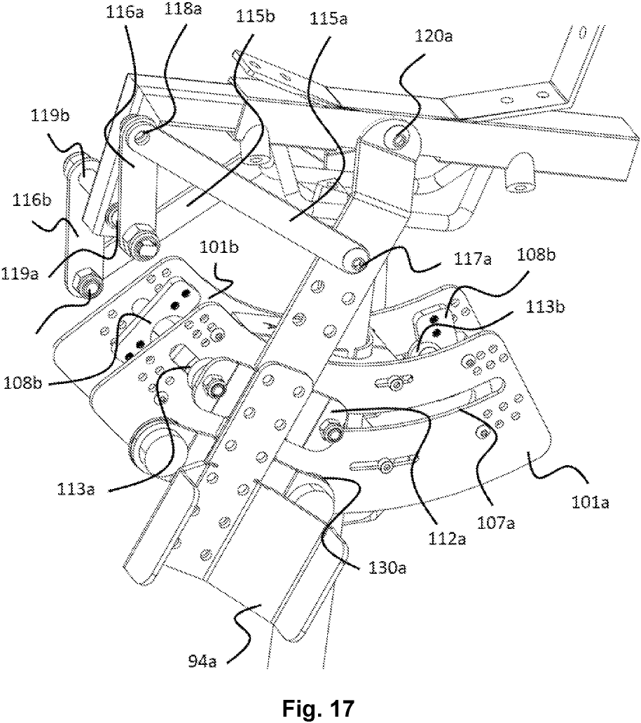

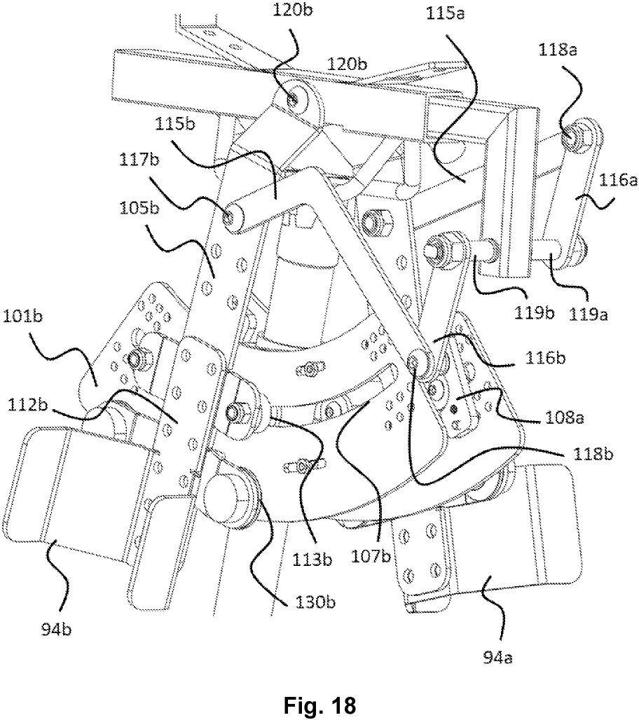

Finally, FIGS. 17 and 18 show the spreading means 8 in a third position in which the right thigh of the patient is placed at the rear whereas the left thigh is placed, at the opposite, at the front, still according to the direction of movement of the orthopedic ambulation assistance device.

The following description covers more specifically these three different positions.

In FIGS. 13 and 14, the spreading means 8 primarily include a first pair of right-side 101a and left-side 101b metallic lower lateral plates fastened to the saddle support rod 7 (not represented), symmetrically and on either side of the latter. Typically, these lower lateral plates 101a and 101b consist of thick sheet metals, for example made of stainless steel with a thickness of several millimeters, and each has an arcuate general shape (angular sector portion).

For example, these first lower lateral plates 101a and 101b are identical and are fastened parallel to one another on a central vertical double-jaw 102 clamped around the saddle rod or tube 7. Moreover, the lower lateral plates 101a and 101b are adjustable back and forth with respect to the central double-jaw 102 (and therefore also with respect to the saddle rod 7) thanks to fastening means 103 such as screws. Thus, each lower lateral plate 101a and 101b is fastened at four different areas 104 (top front, bottom front, top rear, bottom rear) on the central jaw 102 thanks to two pairs of screws 103. In this instance, each fastening area 104 is in the form of an arcuate slot formed throughout the thickness of each lower lateral plate and receiving a screw 103, which allows in particular adapting the spreading means 8 to the morphology of the patient by making the lower lateral plates 101a and 101b tilt/pivot back and forth relative to the saddle rod 7 before tightening the pairs of screws 103 again. Preferably, the right-side lower lateral plate 101a and the left-side lower lateral plate 101b are disposed at the same level.

Each of the lower lateral plates 101a and 101b respectively carries a slender arm 105a and 105b in the form of a perforated rigid metallic ruler (for example made of stainless steel with a thickness of several millimeters) on which a support 106a/106b for a U-like shaped receptacle 94a intended to receive the thigh (right or left depending on the plate/ruler) of the patient is mounted. As is the case with the lower lateral plates 101a and 101b, the right-side 105a and left-side 105b slender arms are disposed parallel to one another on either side of the saddle rod 7.

The right-side slender arm 105a has a right-side tab 112a for connection with a corresponding lower lateral plate 101a. More specifically, the right-side lower lateral plate 101a is provided with a right-side arcuate through groove 107a inside which a pair 113a of front and rear guide rings slip, each of these rings being also screwed on a corresponding connecting tab 112a.

Similarly, the left-side slender arm 105b has a left-side tab 112b for connection with a corresponding lower lateral plate 101b. More specifically, the left-side lower lateral plate 101b is provided with a left-side arcuate through groove 107b inside which a pair 113b of front and rear guide rings slip, each of these rings being also screwed on a corresponding connecting tab 112b.

Moreover, the right-side lower lateral plate 101a is provided with a pair 108a of front and rear stops (according to the direction of movement of the orthopedic ambulation assistance device) against which the front and rear rings 113a respectively bear during their slipping inside the right-side arcuate groove 107a between the first and third extreme positions.

Similarly, the left-side lower lateral plate 101b is provided with a pair 108b of front and rear stops (according to the direction of movement of the orthopedic ambulation assistance device) against which the front and rear rings 113b respectively bear during their slipping inside the left-side arcuate groove 107b between the first and third extreme positions.

Moreover, the right-side slender arm 105a is hinged about a first upper transverse axis 120a crossing the hollow tube 71 and is connected to a low front portion 71′ of said hollow tube 71 of the saddle rod 7 using a system of anterior connecting rods which are hinged respectively about transverse axes parallel to one another and with the upper transverse axis 120a.

More specifically, a first rectilinear large right-side connecting rod 115a extends between a first right-side pivot axis 117a linked to the right-side slender arm 105a and a second right-side pivot axis 118a, whereas a second rectilinear small right-side connecting rod 116a extends between the second right-side pivot axis 118a and a third right-side pivot axis 119a, which is linked to the low front portion 71′ of the hollow tube 71. The second right-side pivot axis 118a is so-called “free” as it is not connected to any part other than the two connecting rods 115a and 116a.

Similarly, the left-side slender arm 105b is hinged about a first upper transverse axis 120b crossing the hollow tube 71 and is connected to a low front portion 71′ of said hollow tube 71 of the saddle rod 7 using a system of anterior connecting rods which are hinged respectively about transverse axes parallel to one another and with the upper transverse axis 120b.

More specifically, a first large left-side connecting rod 115b, this time “L”-like shaped, extends between a first left-side pivot axis 117b linked to the left-side slender arm 105b and a second left-side pivot axis 118b, whereas a second rectilinear small left-side connecting rod 116b extends between the second left-side pivot axis 118b and a third left-side pivot axis 119b, which is linked to the low front portion 71′ of the hollow tube 7. The second left-side pivot axis 118b is so-called “free” as it is not connected to any part other than the two connecting rods 115b and 116b.

The two right-side 119a and left-side 119b third pivot axes are collinear.

Finally, pairs of right-side 130a and left-side 130b guide and stabilization pads in the form of a hemisphere/ball are respectively linked to a lower portion of each of the right-side 105a and left-side 105b slender arms, below the right-side 112a and left-side 112b connecting tabs. These right-side 130a and left-side 130b guide pads respectively permanently bear against an outer lateral wall (also called rolling surface) of each of the right-side 101a and left-side 101b lower lateral plates throughout the back and forth alternating movement of said right-side 105a and left-side 105b slender arms relative to said plates, that being so in order to accompany the movement explained in more detail hereinafter.

Thus, FIGS. 15 and 16 illustrate the second middle intermediate position disclosed before and in which:
the left-side slender arm 105b has pivoted forwards about the first left-side upper transverse axis 120b so as to make the left-side support 106b of the receptacle 94b move forwards, causing the forward movement of the left thigh of the patient and the slipping of the left-side rings 113b forwards in the left-side arcuate groove 107b of the left-side lower lateral plate 101b, and
simultaneously, the right-side slender arm 105a has pivoted rearwards about the first right-side upper transverse axis 120a so as to make the right-side support 106a of the receptacle 94a move rearwards, causing the rearward movement of the right thigh of the patient and the slipping of the right-side rings 113a rearwards in the right-side arcuate groove 107a of the right-side lower lateral plate 101a.

These two opposing and simultaneous movements of the slender arms 105a and 105b (one pivoting forwards causing the other to pivot rearwards) are accompanied with the slipping of the pads 130a and 130b over the respective outer lateral faces of the right-side 101a and left-side 101b plates.

During these synchronized movements, the right-side connecting rods 115a/116a and the left-side rods 115b/116b have also pivoted relative to their respective right-side 117a/118a/119a and left-side 117b/118b/119b axes so as to be in the second position.

It is this set of anterior connecting rods, of guide pads and of rings cooperating with through guide slots that enable the movement of the slender arms 105a and 105b, and therefore of the thighs of the patient, to be smooth, natural, stable, guided and with minimum frictions.

In this second middle intermediate position, the slender arms 105a and 105b, and therefore the thighs of the patient, are substantially opposite one another on either side of the saddle rod 7.

Finally, FIGS. 17 and 18 illustrate the third position of this movable set in which:
the left-side slender arm 105b has continued pivoting forwards about the first left-side upper transverse axis 120b so as to make the left-side support 106b of the receptacle 94b move forwards, thereby causing the forward movement of the left thigh of the patient and the slipping of the left-side rollers 113b forwards in the left-side arcuate groove 107b of the left-side lower lateral plate 101b until the left-side front roller 113b bears against the left-side front stop 108b, and
simultaneously, the right-side slender arm 105a has continued pivoting rearwards about the first right-side upper transverse axis 120a so as to make the right-side support 106a of the receptacle 94a move rearwards, thereby causing the rearward movement of the right thigh of the patient and the slipping of the right-side rollers 113a rearwards in the right-side arcuate groove 107a of the right-side lower lateral plate 101a until the right-side front roller 114a bears against the right-side front stop 109a.

During these synchronized movements, the right-side connecting rods 115a/116a and the left-side connecting rods 115b/116b have also continued pivoting relative to their respective right-side 117a/118a/119a and left-side 117b/118b/119b axes in order to return back in the third position.

It is this set of anterior connecting rods, of guide pads and of rings cooperating with through slots that enable the movement of the slender arms and of the thighs of the patient to be smooth, natural, stable, guided and with minimum frictions.

Thus, throughout the movement of the patient using the ambulation assistance device D in accordance with the invention, an alternating right-side slender arm/right thigh - left-side slender arm/left thigh movement is performed, the forward movement of one slender arm/one thigh causing the rearward movement of the other slender arm/the other thigh, and vice versa. With this kinematics, it is even possible to move rearwards rather than forwards, the rearward movement of one thigh causing the forward movement of the opposite thigh, and vice versa.

The pedal crank and the means for spreading the thighs of the patient of the ambulation assistance device D apart produce walking movements independently of the position of the hip and knee joints of the patient in the space, so that the operation is not affected by the size of said patient.

Moreover, a setting of the level of the connecting rods allows lengthening and/or raising the step of the patient.

Finally, the pedal crank also operates without the motor-drive, by pushing the ambulation assistance device D by a caregiver.

It should be understood that the detailed description of the object of the invention, provided only for illustration, does not form in any manner whatsoever a limitation, the technical equivalents also falling within the scope of the present invention.

1. A gait rehabilitation device, comprising:
a stand equipped with casters spaced apart along a width and a length of the stand, which defines a width and a length of the gait rehabilitation device;
a saddle support optionally equipped with a saddle, which surmounts the stand and extends substantially vertically, according to a height of the gait rehabilitation device;
two movable arms forming a pedal crank, disposed on either side of the saddle support, each movable arm comprising a first end rotatably mounted on the gait rehabilitation device about an axis parallel to the width of the stand;
two wedging elements, each wedging element for wedging a foot or a leg of a patient, the wedging elements being adjustable and lockable in a position according to the width of the gait rehabilitation device; and
a thigh/leg spreader to space thighs or legs of the patient apart on either side of the saddle support, the spacing is adjustable and lockable in a position according to the width of the gait rehabilitation device;
wherein the thigh/leg spreader is configured to follow an alternating movement of lower limbs of the patient maintained by the wedging elements and the thigh/leg spreader, when the patient is installed on the gait rehabilitation device; and
wherein position settings of the wedging elements is independent of a spacing setting of the thigh/leg spreader.

2. The gait rehabilitation device of claim 1, wherein the thigh/leg spreader comprise two branches which extend on either side of the saddle support according to the width of the gait rehabilitation device, a free end of each of the two branches is configured to spread apart from the saddle support according to the width of the gait rehabilitation device and lockable in a position, the free end comprising an element to fix a corresponding thigh or leg, the element being rotatably mounted about an axis parallel to the width of the gait rehabilitation device.

3. The gait rehabilitation device of claim 2, wherein each branch comprises two hinged parts, hinged relative to one another according to parallel axes, the two hinged parts forming a deformable parallelogram, one of the two hinged parts comprising a threaded rod crossing a thread formed in said hinged part, the threaded rod allows deforming the parallelogram formed by the two hinged parts, thereby modifying the spreading of the two branches with respect to the saddle support, according to the width of the gait rehabilitation device.

4. The gait rehabilitation device of claim 1, wherein the thigh/leg spreader is adjustable and lockable in a position according to at least one of a length and a height of the gait rehabilitation device.

5. The gait rehabilitation device of claim 1, wherein the thigh/leg spreader comprises two lower lateral plates mounted parallel to one another on either side the saddle rod, the two lower lateral plates respectively supporting arms to which, supports for thigh or leg receptacles are fastened, the arms pivoting synchronously back and forth and vice versa about a first upper transverse axis and connecting rods pivoting about secondary axes being utilized to alternately switch from a first position to a second position, a rotation of one arm in one direction causing a rotation of other arm in an opposite direction, and vice versa.

6. The gait rehabilitation device of claim 5, wherein each lower lateral plate is fastened on a central double-jaw clamping the saddle rod and is angularly adjustable individually with respect to the central double-jaw.

7. The gait rehabilitation device of claim 6, wherein each lower lateral plate comprises arcuate setting slots cooperating with screws fastened to the central double-jaw.

8. The gait rehabilitation device of claim 5, wherein each lower lateral plate is crossed throughout its thickness by an arcuate guide groove which pairs of rings secured to the arms slip.

9. The gait rehabilitation device of claim 8, wherein each arcuate guide groove comprises front and rear stops which the pairs of rings bear respectively in two extreme positions.

10. The gait rehabilitation device of claim 5, wherein each arm comprises a pair of stabilization and guide pads constantly bearing against outer lateral faces of the corresponding lower lateral plates.

11. The gait rehabilitation device of claim 1, further comprising a central beam which extends according to the length of the stand and wherein a second end of said each movable arm is mounted slidably along the central beam and pivotably according to an axis parallel to the width of the gait rehabilitation device.

12. The gait rehabilitation device of claim 1, further comprising a drive controller to drive the two movable arms forming the pedal crank, the drive controller being configured to alternately drive the two movable arms in a rotational movement combined with a translation.

13. The gait rehabilitation device of claim 12, wherein the drive controller comprises at least one of a rotary motor and a wheel connected to the two movable arms, configured to touch the ground and to be rotationally driven by a movement of the gait rehabilitation device on the ground.

14. The gait rehabilitation device of claim 12, further comprising a unique and common motor-drive device to control both alternating movement of the pedal crank and movement of rear wheels.

15. The gait rehabilitation device of claim 14, wherein the motor-drive device comprises a central motor driving the two movable arms of the pedal crank through a first belt connected to a gearmotor and the rear wheels through a second belt connected to a dis-engageable gearmotor.

16. The gait rehabilitation device of claim 12, further comprising a first central motor driving the two movable arms of the pedal crank and independent motors to drive each rear wheel.

17. The gait rehabilitation device of claim 16, further comprising a manual piloting joystick/lever integrated to an armrest and piloting one of the motors.

18. The gait rehabilitation device of claim 1, further comprising a foot bar which comprises a sole whose lower surface is equipped with at least one rotary hooking element, said at least one hooking element being made of an elastically-deformable material and rotatably mounted about an axis passing through a plane defined by the sole and forming a non-zero angle with a longitudinal dimension of the sole.

19. The gait rehabilitation device of claim 1, wherein said each wedging element is mounted on a corresponding movable arm by a mounting element, the mounting element comprising a damper to dampen vertical movements of said each wedging element.

20. The gait rehabilitation device of claim 1, further comprising a steering guide to steer the gait rehabilitation device, the steering guide being one of the following: a handlebar secured to a caster configured to touch the ground and disposed at a front of the gait rehabilitation device, a bidirectional wheel coupled to at least one of motor-driven rear casters equipping the stand or a gripper enabling an assistant to push the gait rehabilitation device; wherein the steering guide comprises at least one of a steering controller to control the steering guide and a starter to start and stop the drive controller of the two movable arms; wherein the steering controller and the starter are selected independently of each other amongst a joystick, sensors disposed on the optional saddle, sensors equipping a holder to maintain a bust of the patient and a gyroscope positioned so as to enable activation thereof by the patient.
